(19) United States
(12) Patent Application Publication
(10) Pub. No.: US 2022/0032461 A1
(43) Pub. Date: Feb. 3, 2022

(54) METHOD TO INCORPORATE COMPLEX PHYSICAL CONSTRAINTS IN PATH-CONSTRAINED TRAJECTORY PLANNING FOR SERIAL-LINK MANIPULATOR

(71) Applicant: GrayMatter Robotics Inc., Los Angeles, CA (US)

(72) Inventors: Satyandra K. GUPTA, Los Angeles, CA (US); Ariyan M. KABIR, Los Angeles, CA (US); Brual C. SHAH, Los Angeles, CA (US)

(73) Assignee: GrayMatter Robotics Inc., Los Angeles, CA (US)

(21) Appl. No.: 17/390,885

(22) Filed: Jul. 31, 2021

Related U.S. Application Data
(60) Provisional application No. 63/059,932, filed on Jul. 31, 2020.

(51) Int. Cl. B25J 9/16; B25J 11/00

(52) U.S. Cl. CPC B25J 9/1666; B25J 9/1697; B25J 11/0065; B25J 9/163; B25J 9/1653

(57) ABSTRACT

A method of generating robot trajectories for a robot device includes generating surface parameters and/or measurements for the surface of the object; receiving one or more parameters to maximize or minimize robot objectives; receiving one or more motion parameters for the robot to perform the task on the surface of the object and/or receiving one or more workspace parameters; receiving a plurality of constraint parameters; and generating an initial parametric representation of a trajectory for the robot in performing the task. The method further includes generating an initial trajectory based on the initial parametric representation of the trajectory, one or more workspace parameters, the one or more motion parameters, and/or the one or more parameters to maximize or minimize robot objectives; selecting a first set of constraint parameters; and performing trajectory generation by applying the selected first set of constraint parameters to create one or more first robot trajectories.

### RELATED APPLICATIONS

This application is related to and claims priority to U.S. provisional patent application Ser. No. 63/059,932, filed Jul. 31, 2020, entitled “A METHOD TO INCORPORATE COMPLEX PHYSICAL CONSTRAINTS IN PATH-CONSTRAINED TRAJECTORY PLANNING FOR SERIAL-LINK MANIPULATORS,” the disclosure of which is hereby incorporated by reference.

### BACKGROUND

Robots are emerging as useful tools in many applications to overcome physical constraints of human physiology (e.g., size, force, speed, precision etc.) and reduce the need for humans to perform dangerous and ergonomically challenging tasks. Many emerging applications require the robot to continuously move a tool over a specified path. A first representative example is that many manufacturing applications require concurrently manipulating objects and tools. The process requires the tool to move along a path determined on the part's surface. A 6 or 7-Degree of Freedom (“DOF”) manipulator can hold the large part and another 6 or 7-DOF manipulator can operate the polishing tool. The complete surface area of the large part is not reachable with the desired tool orientation by one manipulator. However, in this bi-manual setup, one robot can move the part and the other can operate the tool simultaneously. Theoretically the speed of the process can be doubled by moving both the manipulators at their maximum speed. Other potential applications include composite manufacturing and/or painting, finishing, wire harnessing, and sheet metal forming and handling.

A second representative example is that many manufacturing and material handling tasks require the robot to manipulate the material over large distances. These tasks cannot be performed with traditional industrial manipulators. Mobile manipulators are emerging as a useful tool in such applications. Mobile manipulators typically have a mobile base with 3 DOF and an arm of 6 or 7 DOF. This results in systems with combined DOF of 9 or 10.

In many traditional applications, robots are either teleoperated or programmed by humans. For example, in mass production applications, human operators program the robots to perform manufacturing tasks (e.g., welding, painting, etc,). Currently, surgeons tele-operate robots to perform minimally invasive surgery. Unfortunately, these two approaches are not practical in many emerging applications. Using humans to program robots in non-repetitive or low volume manufacturing tasks such as finishing is not viable as this significantly increases costs and reduces throughput. On the other hand, deploying tele-operated robots is not a scalable concept in many applications due to the limited availability of human operators. In order to utilize robots effectively, we will need to use automated trajectory planners that can generate trajectories for robots using task models.

Accordingly, a need exists for automated trajectory planners that may generate trajectories for robots or serial link manipulators using task models.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates a block diagram of a trajectory generation system or process according to some implementations;

FIG. 2 illustrates submodules of the trajectory representation selector module according to some implementations;

FIG. 3 illustrates submodules of an objective modeler module according to some implementations;

FIG. 4 illustrates a constraint modeler module 120 according to some implementations;

FIG. 5 illustrates submodules of a constraint selector module according to some implementations;

FIG. 6 illustrates submodules of a trajectory generator module according to some implementations;

FIG. 7 illustrates a robot sanding tool according to some implementations;

FIG. 8 illustrates challenges in solving constraints in a two dimensional continuous parameter space according to some implementations;

FIG. 9 illustrates a trajectory generation process implemented by a trajectory generating system according to some implementations;

FIG. 10 illustrates a successive constraint refinement process that may be utilized in generating a final robot trajectory according to some implementations;

FIG. 11A illustrates a tool that is attached to a robot according to some implementations;

FIG. 11B illustrates a part or surface and toolpaths of robot trajectories on the part or surface according to some implementations;

FIG. 12 illustrates a robot that is in a singularity position according to some implementations; and

FIG. 13 illustrates cabling in a robot as well as a cabling constraint issue according to some implementations;

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

Significant progress has been made in developing automated trajectory planners for serial link manipulators or robots. Given (1) geometric model of the environment, (2) dynamics model of the robot, and/or (3) initial and goal configuration of the robot, a trajectory planner produces a collision free robot trajectory. Many trajectory planners are able to optimize trajectories with respect to time or energy.

Currently designing a good trajectory planner for a given robot and/or application context takes a significant amount of effort even for a 6 or 7 DOF robot. As an example, the trajectory planner requires selecting the right representation of a workspace to effectively perform collision detection, identifying state-space representation to represent on option space in computationally efficient manner, selecting the search strategy, and developing heuristics to guide the search. Many robotic applications require near real-time performance. Therefore, many parameters need to be carefully tuned to produce trajectory planners with good computational performance.

Robots may refer to serial link manipulators, mobile manipulators, mobile manipulators having a base and one or more links or arms, as well as other similar devices. These terms may be utilized interchangeably in the application.

The trajectory planner is used for robotic applications that require one or more robots to move a tool or object in a specified manner. The trajectory is generated by constraining a reference point on the robot (e.g., tip of end-effector) to follow a path-constraint. The path-constraint can be the relative path between a tool and a workpiece or an object's given path in the robots' workspace. Therefore, generation of trajectories for a robotic system is viewed as generation of configuration space trajectories for robots that follow path constraints in the workspace. We will refer to these trajectories as path-constrained trajectories in this document. Trajectories may also be referred to as robot trajectories.

Generation of path-constrained trajectories to produce motion among robots may be formulated as an optimization problem. In generating path-constrained trajectories, objectives of the operation may be to minimize operation time (e.g., trajectory execution time or how long it takes to complete a trajectory) and generate a safe trajectory (e.g., collision free) that satisfies physical and application specific constraints in the workplace. It is difficult to solve the problem of generating path-constrained trajectories using traditional non-linear optimization methods because it is not computationally feasible due to complex constraints (e.g., path-following, collision avoidance, other physical constraints, application constraints, etc.) and a large number of variables that may be involved.

In existing systems, there are three primary approaches for generating constrained trajectories for serial-link manipulator robots. These different approaches are described below.

Sampling-based approaches have been widely used for motion planning of high degree of freedom systems such as serial-link manipulators (robots). Many variants of Probabilistic Roadmaps (PRMs), and Rapidly-exploring Random Trees (RRTs) have been developed for motion planning by improving computational efficiencies using techniques such as biased sampling, increasing convergence rates, anytime convergence, heuristic guided sampling, and/or having sub-optimality bounds. In addition, recent sampling-based approaches such as fast marching trees (FMT*) and batch informed trees (BIT*) attempt to improve RRT performance in high dimensional problems.

Additional path constraint trajectory generation includes exploring/exploiting workspace cues for planning in the configuration space. These trajectory planning systems end up finding more intuitive end-effector trajectories as compared to sampling-based algorithms that work only in configuration space. As an example, contact space and narrow passages are handled which is important for planning in cluttered environments. Asymptotically optimal manipulation trajectory planning systems are used for pick and place operations. In another example, a quotient space decomposition of the configuration space has been implemented to work in higher dimensions only when necessary. Researchers have also explored sampling-based approaches and genetic algorithms to generate path-constrained trajectories for manipulators or robots. However, these combined sampling and genetic algorithm approaches can be computationally expensive when trying to find a feasible solution in high dimensional problem environments.

Two additional types of methods have been developed for converting given paths (or path constraints) into trajectories. The first type of trajectory generation methods use inverse Jacobian based control to generate robot joint trajectory to track the given path. The second type of trajectory generation method uses non-linear optimization to compute parameters of joint trajectories to optimize the given objective function. We describe more about the optimization-based methods below. Quadratic Programming (QP) has been used to solve a certain class of trajectory generation optimization problems. Joint velocity control-based manipulator trajectory generation approaches or methods use Jacobian approximations for generating joint configurations to minimize the time to execute a path-constrained trajectory. It is important to note that the higher order Jacobian approximation is close to the actual value resulting in reduced error in the end effector trajectory, so it is necessary to give a valid initial joint configuration for the manipulator. For a redundant manipulator, the quality of the trajectory solution is highly dependent on this initial joint configuration.

Exploring/exploiting workspace cues for trajectory generation and/or planning in the configuration space. These trajectory planner systems end up finding more intuitive end-effector trajectories as compared to sampling-based algorithms that work only in configuration space. In such trajectory generation systems, contact space and narrow passages are handled which is important for planning in cluttered environments. Asymptotically optimal manipulation planning may be used for pick and place operations. In one system, a quotient space decomposition of the configuration space has been implemented to work in higher dimensions only when necessary. Some other individuals explored sampling-based approaches and genetic algorithms to generate path-constrained trajectories for manipulators. However, these approaches can be computationally expensive to find a feasible solution in high dimensional problem environments.

Additional trajectory generation methods reduce the necessity of control actions by relaxation of certain constraints to find trajectories. These methods use linear approximations of the constraints for sequential QP solving of generating the trajectories. In other trajectory generation systems, inverse kinematics using optimization methods are implemented, since Jacobian Inverse techniques can result in false negative failures in high degree of freedom systems. For example, a Descartes library uses graph search on inverse kinematics (IK) solutions at sampled points on a workspace path for trajectory generation. However, such search-based approaches can be computationally expensive as the branching factor in the graph increases with the number of joints that are part of the manipulator or robot. Inverse kinematic branching for trajectory of mobile robot manipulators may be utilized. Inverse Jacobian-based control is used for tracking the end-effector trajectory while placing the mobile base at appropriate location for tasks like wall painting.

Efforts have been made to combine sampling-based trajectory generation approaches with Jacobian-based generation approaches to improve performance of robot manipulators and mobile robot manipulators.

Path-constrained trajectories require manipulators to move their end-effectors through a set of waypoints in a continuous motion which has been studied mostly for a single robot manipulator. Researchers have developed methods to optimize predefined trajectories or generate trajectories from pre-defined configuration space paths by minimizing time, jerk, and effort under joint position, velocity, and torque constraints of the manipulator. In these embodiments, a solution for each joint angle for the complete trajectory is found either as a functional using optimal control or as a parametric curve using discrete parameter optimization. Cubic spline and B-spline approximation of joint trajectories have been used with Sequential Quadratic Programming (SQP) to solve the problem. However, these approaches are not able to generate trajectories without an initial configuration space path.

Configuration space path can be generated from a given workspace path and then converted it to configuration space trajectory. In some implementations, the trajectory generation system considered parametric representation of each joint motion using B-Splines and formulated the minimum-effort trajectory generation problem as a sequential quadratic programming (SQP). These trajectory generation systems used lie algebra and group theory to convert the optimization problem into SQP with optimization variables being the control points of the B-Spline curves. In these trajectory generation systems, joint limits, joint velocity, and end-effector pose were presented as constraints over the duration of motion. The quality of the generated trajectory and success of these methods depend on a good initial seed and appropriate parametric representation, which can be challenging to find. B-Splines may be referred to as spline segments.

Trajectory generation for high-DOF systems has been studied for bi-manual manipulation, mobile manipulation, and manipulation using humanoids. Convex optimization and QP have been studied to generate trajectories for high-DOF systems in dynamic environments. One trajectory generation system proposed a QP-based IK-solver for coordinated multi-arm motion generation in a dynamic environment. In another trajectory generation system, a convex optimization problem was formed or generated for the task of multi-robot deformable object manipulation. They used a global trajectory motion planner for high level trajectory generation for the robots and a receding horizon local motion planner that ensures collision avoidance and shape maintenance for the deformable object. Another trajectory motion planner or generator utilized QP-based approach to solve local motion planning for whole body manipulation of a high-DOF robotic system (humanoid or mobile manipulator). This trajectory motion planner formulation can take collision avoidance and other geometric constraints as constraints to the QP or as part of the objective function.

Many manipulation tasks often require high DOF robots to satisfy multiple constraints. Some of these constraints are strict and some are flexible. One trajectory generation system presented an approach for trajectory planning of humanoids using hierarchical quadratic programming. The core idea of this system was to solve the QP for one constraint at a time. In other trajectory generation systems, non-linear programming, Constrained Quadratic Programming (cQP) and Quadratic Programming (QP) have been used to generate time-optimal trajectory by minimizing pose error (by estimating pose using Jacobian). Joint limit and velocity have been considered as constraints. Collision, path smoothness, and manipulability have been explored as part of the objective function. However, it is often challenging to represent some constraints (e.g., mesh-to-mesh collision) in a quadratic format. Optimization-based approaches have been studied for point-to-point trajectory planning as well. Two representative methods developed for manipulator trajectory planning are CHOMP: Covariant Hamiltonian Optimization for Motion Planning, and Stochastic Trajectory Optimization for Motion Planning (STOMP).

Most of the studied methods for generating constrained trajectories for serial-link robot manipulators only consider path constraints for the end-effector. The existing trajectory generation methods are not capable of accounting for different robot constraints, robot-controller constraints, tool-path constraints, sensor constraints, rigid object constraints, and flexible object constraints

Described herein is a new method and/or system for generating path-constrained trajectories for robotic systems. The method and/or system described herein allows users to automatically incorporate complex physical constraints associated with the robot, the controller, the toolpath of the tool associated with the robot, the sensor associated with the robot, and flexible objects present in the workspace. The method and/or system described herein is adaptive in generating trajectories and may automatically adjust a level of detail to ensure that high quality trajectories are generated in a computationally efficiently manner (e.g., minimize computer resources while also minimizing execution time). Computer software programs that evaluate constrains during the process tend to require large processing power and/or execution time by the computing devices running the programs (e.g., constraint evaluation is computationally expensive).

The method and/or system described herein extracts maximum information from each constraint evaluation in order to speed up the path-constrained trajectory computation. In some implementations, the path-constrained trajectory generation software may select correct representations and/or developed models that may predict constraint violations based, at least in part, on prior constraint evaluations performed by the path-constrained trajectory generation software.

Traditional optimization approaches for path-constrained trajectory generations that are based on initially using a random trajectory solution and applying all constraints concurrently to the initial trajectory solution during the trajectory optimization process is not likely to produce an acceptable trajectory solution. The method and/or system described herein applies constraints is predetermined sequences in order to generate successful robot trajectories by application of a successive refinement process. Further, other trajectory generator systems assume or rely upon the fact that constraints or constraint parameters can be expressed as linear or quadratic functions. In this case, handling multiple constraints may not be difficult. However, many constraints arising in robot trajectory planning problems cannot be represented as linear or quadratic functions, therefor existing methods based on Constrained Quadratic Programming cannot be used for solving such problems. The trajectory generation system described and claimed herein addresses these problems that require a large number of constraints to be considered by improved modeling of constraints and/or constraint parameters and the trajectory generation system described herein can address problems where the constraints cannot be expressed as linear or quadratic functions. For example, the trajectory generation system described herein can operate with constraints that cannot be expressed as linear and quadratic functions such as: Collision Avoidance constraints, Multiple Tool Center Point Constraints, Sensor Constraints, Robot Controller Constraints, Force Controller Constraints, Impedance Controller Constraints, and/or Flexible Object Constraints. These constraints or constraint parameters could not have been addressed by prior art systems.

The trajectory generation system described herein has new and unique functionality. In some implementations, the trajectory generation system may select a correct representation of a high dimensional configuration space trajectories for robots so that required trajectories' features can be preserved to carry out the required tasks in the workspace. The trajectory generation system may generate an initial configuration of the robots with respect to the objects to complete the motion needed for task execution, which eliminates the need for solving the robot and/or object placement problem before generating trajectories. The trajectory generation system may be able to exploit all degrees of freedoms of the robots during execution of performing of the task to magnify and/or improve relative speed and/or expand potential operational workspace of the individual robots, which allows manipulation of large objects and reduces operation time.

In some implementations, a robot trajectory may include values for a plurality of time instances. In some implementations, the robot trajectory may be a workspace trajectory. In workspace trajectories, each time instance (or timepoint) has associated x, y and z coordinates as well as orientation parameters for the tool on the robot (where the orientation parameters include pitch, roll and yaw angular measurements.). In some implementations, the robot trajectory may be a configuration space trajectory. In configuration space trajectories, each time instance (or timepoint) has associated angular measurements for each of the joints in the robot. The angular position is the angle that robot joint should be positioned in at each of the time instances.

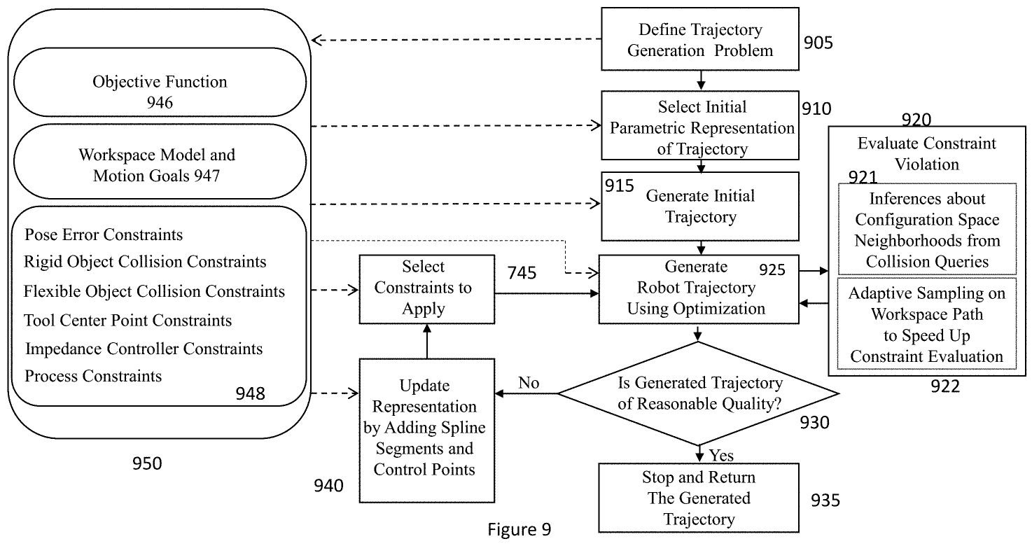

FIG. 9 illustrates a trajectory generation process implemented by a trajectory generating system according to some implementations. In FIG. 9, for example, pose error constraints or constraint parameters, the rigid object collision constraints or constraint parameters, the flexible object collision constraint parameters, the tool center point constraint parameters, the impedance controller constraint parameters and/or other process constraint parameters may be stored in the one or more memory devices 950. While the term constraint parameters is utilized herein, the term constraints, constraint functions and/or constraint equations may also be utilized to describe constraints that are to be applied in generating robot trajectories. The constraints may be represented by many different models as is described below. In FIG. 9, workspace model parameters and/or measurements and/or motion goal parameters 947 may also be stored in the one or more memory devices 950 of the computing device associated with the robot. In some implementations, the workspace model parameters and/or measurements may include robot and/or other objects position information, robot configuration information, part location and/or other similar information and/or measurements. In some implementations, workspace parameters may include a description of the workspace and/or part generated by measurements and/or images, description of the robot or manipulator, description of the tool and/or descriptions of other objects in the workspace such as fixtures and/or a worktable. In some implementations, the motion goal parameters and/or measurements may include paths that may be followed in the workspace including the robot. In some implementations, objective function and/or objective function parameters 946 may also be stored in the one or more memory devices 950 in order to be utilized in the trajectory generation process. In some implementations, the objective functions and/or goals that may need to be achieved and/or utilized by the trajectory generation system when generating acceptable trajectories and may include minimizing execution time for the task to be performed, minimizing path length traveled by the robot in performing the task, and/or minimizing robot energy consumption when performing the task.

In some implementations, a computing device (e.g., a desktop computing device, a server computing device, a laptop computing device or a computing device associated with and/or integrated with a robot (e.g., a manufacturing robot having an end effector or tool)) may create and/or generate a robot trajectory (or trajectoties) that is a significant improvement over trajectories generated by prior robot trajectory systems. In some implementations, the computing device may include one or more processors, one or more memory devices and/or computer-readable instructions stored in the one or more memory devices. In some implementations, the computer-readable instructions may be accessible from the one or more memory devices and may be executable or executed by the one or more processors in order to complete the steps and/or actions described below. The computing device, one or more memory devices, one or more processors and executable computer-readable instructions may be referred to as the trajectory generation system for ease or simplicity and refers to an ability to automatically generate the one or more robot trajectories to be traveled by the tool of the robot.

In some implementations, a robot and/or an imaging device integrated and/or installed thereon may scan a part and/or a surface on which a robot may be performing an action. In some implementations, the action performed on the part and/or surface may be to sand the part and/or surface, to debug the part and/or surface, to buff the part and/or surface, and/or to paint the part and/or surface. In some implementations, the robot and/or imaging device may capture the curves, shapes, sizes and/or orientation of the part and/or surfaces. In some implementations, the trajectory generation system may generate surface parameters and/or measurements based on the captured curves, shapes, sizes and/or orientations of the surface (or surfaces). In some implementations, the trajectory generation system may also receive parameters and/or measurements a workspace in which the part and/or surface is located (e.g., part of the workspace model parameters and/or measurements).

In some implementations, in step 905, the trajectory generation system, in order to define the trajectory generation problem, may receive objective functions or objection function parameters that may be utilized in solving the trajectory generation problem. In some implementations, these objective functions may include minimizing path length of a robot, minimizing execution time of robot, and/or minimizing energy consumption when performing the robotic task. In some implementations, the trajectory generation system may also receive motion parameters and measurements for performing the robot task. In some implementations, the objective function parameters and/or the motion parameters or measurements may be received from the one or more memory devices 950. In some implementations, the trajectory generation system may also receive constraints or constraint parameters from the one or more memory devices 950. In some implementations, the workspace model parameters and/or measurements may also be received from the one or more memory devices 950.

In some implementations, in step 910, the trajectory generation system may generate an initial parametric representation of a robot trajectory for performing the robotic task. In some implementations, the trajectory generation system may utilize the part/surface measurements and/or parameters, the objective function parameters, and/or motion parameters and/or measurements to generate an initial parametric representation of trajectory for performing the robotic task. In some implementations, the initial parametric representation of the robotic trajectory may specify or may estimate how many control points and/or spline segments may be utilized to define the robot trajectory.

In some implementations, in step 915, the trajectory generation system may generate an initial robot trajectory (or initial robot trajectories) for performing the robotic tasks. In these implementations, the trajectory generation system may utilize the initial parametric representation of the robot trajectory along with the objective functions, the motion parameters, and/or the workspace model parameters in generating the initial robot trajectory. In these implementations, the trajectory generation system, during step 915, may generate a preliminary estimate of control points for the spline segments as part of the initial robot trajectory. During step 915, the trajectory generation system does not utilize constraints or the constraint parameters in generating the initial robot trajectory.

In some implementations, in step 945, trajectory generation system may select a first set of constraints or constraint parameters to apply when generating the first robot trajectory. For example, in some implementations, the trajectory generation system may apply two or three constraint values or parameters (e.g., a first set of constraints or constraint parameters) to generate one or more first robot trajectories. This step is an improvement over prior trajectory generations systems where sets of constraints or constraint parameters were not selected.

In some implementations, in step 925, during a first optimization stage, the trajectory generation system may generate the one or more first robot trajectories by applying the one or more constraints or constraint parameters selected during step 945 to the initial robot trajectory. This is a first step in what is a novel and new constraint refinement process for generating high quality robot trajectories.

In some implementations, in step 920, the trajectory generation system may utilize a constraint violation evaluation module to improve performance in generating the one or more robot trajectories during the optimization stages. In some implementations, in step 921, in one part of the constraint evaluation module, the trajectory generation system may generate inferences or inference values about a robot workspace by analyzing constraint violations including prior collisions in robot configurations that have utilize the proposed robot trajectories and apply these inferences to improve performance and/or quality of the generated robot trajectories. Further, in some implementations, in step 922, the robot generation system may analyze paths in the one or more robot trajectories and adaptively sample an adequately large number of points for curved or complex shapes in the paths and/or adaptively sample a lower number of points for straight or linear shapes in the paths. In other words, the robot trajectory system may adaptively sample points on the one or more first robot trajectories, wherein the adaptive sampling is based, at least in part, on a shape complexity of one or more portions of paths in the one or more first robot trajectories.

In some implementations, in step 930, the trajectory generation system may determine whether the one or more first robot trajectories are of acceptable quality to be utilized by the robot in performing the identified robotic task. In some implementations, the trajectory generation system may determine quality of the one or more first robot trajectories by evaluating the one or more first robot trajectories based on constraint violations or constraint parameter violations. For example, if the one or more first robot trajectories have any constraint violations, the one or more first robot trajectories may be considered of poor quality. In some implementations, the trajectory generation system may determine quality of the one or more first robot trajectories by evaluating the one or more robot trajectories with respect to the objection functions or the objective function parameters. If, for example, the one or more first robot trajectories have too long of a path length involving many turns, then the one or more first robot trajectories are considered of poor quality. As an example, if one or more robot trajectories include points close to singularity, the one or more first robot trajectories may be determined to be of low quality. In some implementations, if the one or more first robot trajectories are of poor quality, the trajectory generation system may begin to initiate a second optimization stage. In some implementations, the trajectories from one optimization stage may be utilized by the next optimization stage.

In some implementations, in step 940, the trajectory generation system may update the initial parametric representation and create an updated parametric representation of the robot trajectory based on the one or more first robot trajectories. In some implementations, the updated parametric representation may include adding one or more (or a plurality of) spline segments and/or one or more control points (or a plurality of control points).

In some implementations, in step 945, the trajectory generation system may select an expanded set of constraints or constraint parameters that may be applied to the one or more generated first robot trajectories during the second optimization stage. In some implementations, in step 945, the trajectory generation system may retrieve the expanded set of constraints or constraint parameters from the constraints or constraint parameters 948 stored in the one or more memory devices 950). In some implementations, the expanded set of constraints or constraint parameters includes the constraints or constraint parameters utilized in the first optimization stage.

In some implementations, in step 925, during the second optimization stage, the trajectory generation system may generate one or more second robot trajectories by applying the selected expanded set of constraints or constraint parameters to the one or more first robot trajectories. In other words, the trajectory generation system may utilize the results of the preceding optimization stage when performing the next optimization phase until the generated one or more trajectories are of sufficient quality. In addition, in some implementations, the trajectory generation system may evaluate constraint violations or constraint valuation parameters, as discussed above with respect to steps 920, 921 and 922, as part of the second optimization stage.

In some implementations, in step 930, the trajectory generation system may analyze the one or more second robot trajectories to determine if the one or more second robot trajectories are of sufficient quality levels, as discussed above. If the one or more second robot trajectories are not of sufficient quality levels, the trajectory generation system may continue the trajectory generation process by 1) updating the trajectory parametric representation by adding spline segments and/or control points; 2) selecting an additional expanded set of constraints or constraint parameters (which includes the previously applied constraints or constraint parameters); and 3) generating one or more additional robot trajectories (in subsequent optimization stages) until one or more additional robot trajectories are determined to be of sufficient quality to be provided and/or then utilized by the robot. This successive constraint refinement process of the trajectory generation system described herein provides the advantage, as compared to prior systems and/or processes, of generating high performing and high-quality robot trajectories that meet and do not violate a plurality of constraints or constraint parameters.

Further, the robot trajectories generated by the successive constraint refinement process have shorter path lengths, lower execution times and/or consume lower energy than robot trajectories generated by prior trajectory generation processes or systems.

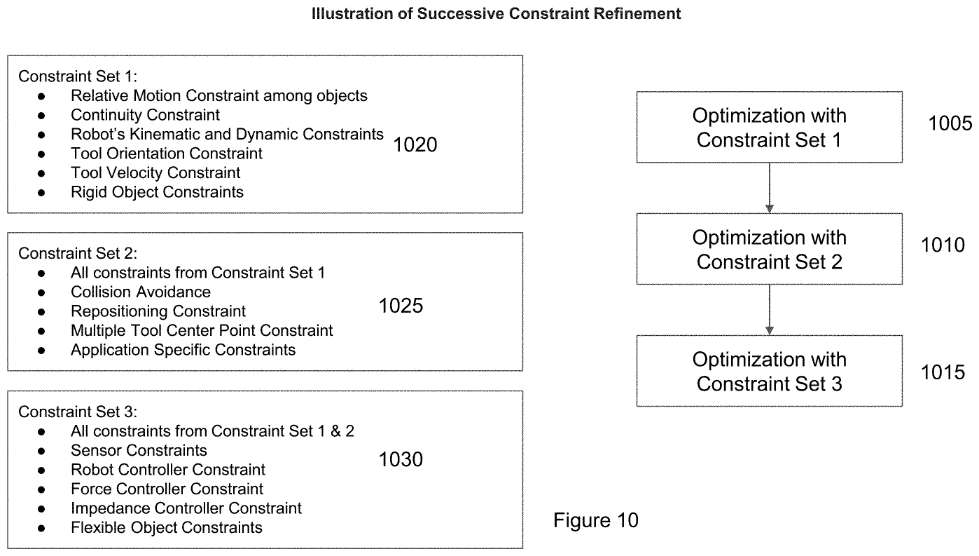

FIG. 10 illustrates a successive constraint refinement process that may be utilized in generating a final robot trajectory according to some implementations. In some implementations, in step 1005, in a first optimization stage, the trajectory generation system may apply a first set of constraints or constraint parameters in generating the one or more first robot trajectories. In the implementation illustrated in FIG. 10, the first set of constraints or constraint parameters 1020 may include relative motion constraint among object constraints or constraint parameters, continuity constraints or constraint parameters, robot kinematic and/or dynamic constraints or constraint parameters, tool orientation constraints or constraint parameters, tool velocity constraints or constraint parameters, and/or rigid object constraints or constraint parameters. In some implementations, in step 1010, in a second optimization stage, the trajectory generation system may apply a second set of constraints or constraint parameters in generating one or more second robot trajectories. In the implementation illustrated in FIG. 10, the second set of constraints or constraint parameters 1025 may include all of the constraints from the first set of constraints or constraint parameters, collision constraints or constraint parameters, repositioning constraints or constraint parameters, multiple tool co-center point constraints or constraint parameters, and/or application specific constraints or constraint parameters. In some implementations, in step 1015, in a third optimization stage, the trajectory generation system may apply a third set of constraints or constraint parameters in generating one or more third robot trajectories. In some implementations, the third set of constraints 1030 may include all of the constraints or constraint parameters from the first and second set of constraints or constraint parameters 1020 and 1025 and/or sensor constraints or constraint parameters, robot controller constraints or constraint parameters, force controller constraints or constraint parameters; impedance controller constraints or constraint parameters; and/or flexible object constraints or constraint parameters.

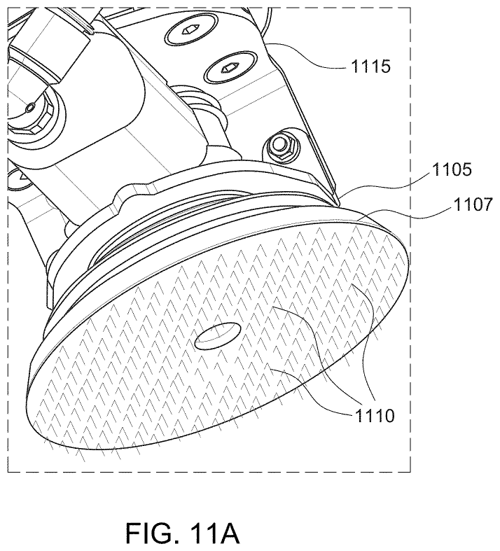

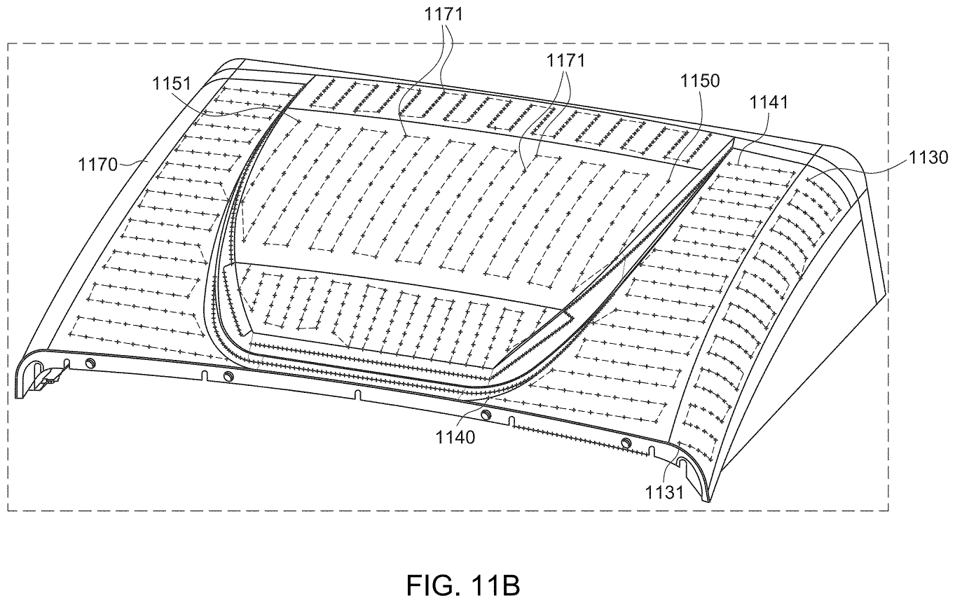

FIG. 11A illustrates a tool that is attached to a robot according to some implementations. FIG. 11B illustrates a part or surface and toolpaths of robot trajectories on the part or surface according to some implementations. In some implementations, as illustrated in FIG. 11A, the robot or manipulator 1115 may include an end effector 1105. In some implementations, the end effector 1105 may be coupled, attached or connected to a tool 1107. In some implementations, the tool 1107 may be a sanding tool, a polishing tool, a buffing tool, a grinding tool, a deburring tool or a spraying tool. In some implementations, the tool 1107 may include a plurality of tool center points (TCP or TCPs) 1105 on a contact surface of the tool 1107. In some implementations, a contact surface of the tool 1107 may be a bottom surface of the tool.

In some implementations, as illustrated in FIG. 11B, a part or surface 1170 (on which a robot is perform the robotic task) is placed in an environment. As is illustrated in FIG. 11B, the part or surface 1170 has many curves, contours and/or shapes that a robot tool 1107 should be made aware of. In some implementations, the dotted lines on the part or surface are toolpaths where one or more TCPs should be in contact with the part or the surface. In some implementations, these are toolpaths in a physical workspace. In some implementations, the trajectory generation system may generate one or more robot trajectories for the one or more toolpaths. As discussed previously, the one or more robot trajectories may be configuration space trajectories or workspace trajectories. FIG. 11B illustrates three toolpaths 1130 and 1131, 1140 and 1141, and 1150 and 1151. In these implementations, the starting point of a first toolpath may be 1130, the starting point of a second toolpath may be 1140 and the starting point of a third toolpath may be 1150. In these implementations, the ending points of the first toolpath may be 1131, the ending point of the second toolpath may be 1141 and the ending point of the third toolpath may be 1151. In some implementations, the dots or circular areas may be waypoints 1171 on the one or more toolpaths. In some implementations, one or more TCPs 1105 may contact a part or surface at the one or more waypoints 1171. In some implementations, other TCPs may also make contact with a part or surface due to a construction and/or design of a tool.

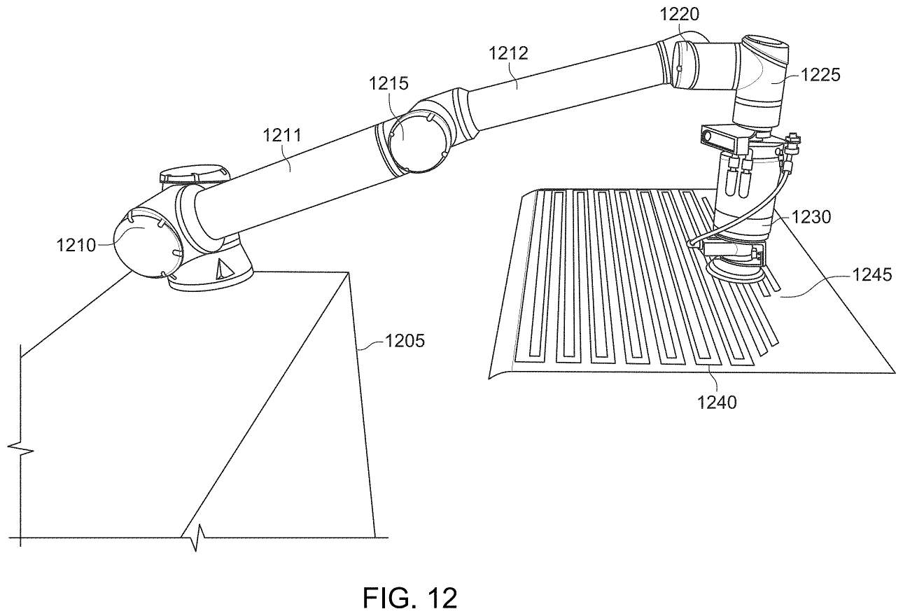

FIG. 12 illustrates a robot that is in a singularity position according to some implementations. In FIG. 12, the robot includes a base 1205, a first joint 1210, a first arm or link 1211, a second joint 1215, a second arm or link 1212, a third joint 1220, a third robot link 1225, a tool 1230. In some implementations, the robot tool 1230 may be contacting the workplace surface at 1245 (as shown in FIG. 12). In some implementations, the workspace may have one or more toolpaths, where the one or more toolpaths are represented by reference number 1240. In this case, the robot tool 1230 has reached a singularity position (or singularity) because the joints are in line (e.g., the first joint 1210 and first arm 1211 are in line with the second joint 1215 and the second arm 1212). In other words, in this position, the joints (and/or motors associated with the joints) are not moving independently. This reduces the degrees of freedom and ability to achieve the desired end-effector velocity. If the robot is in such a singularity position, parts of the motors including the gears, shafts, etc. may be overworked because the robots are not designed to operate in this type of configuration). In some implementations, this also slows down an operation of the robot because the joint and/or motors that are in line with each other have to operate in tandem. In other words, while the robots can reach certain points (e.g., the points of singularity), but the velocity may be reduced as the robot approaches these points. This way of moving the robot may interfere with the operation of the impedance controller.

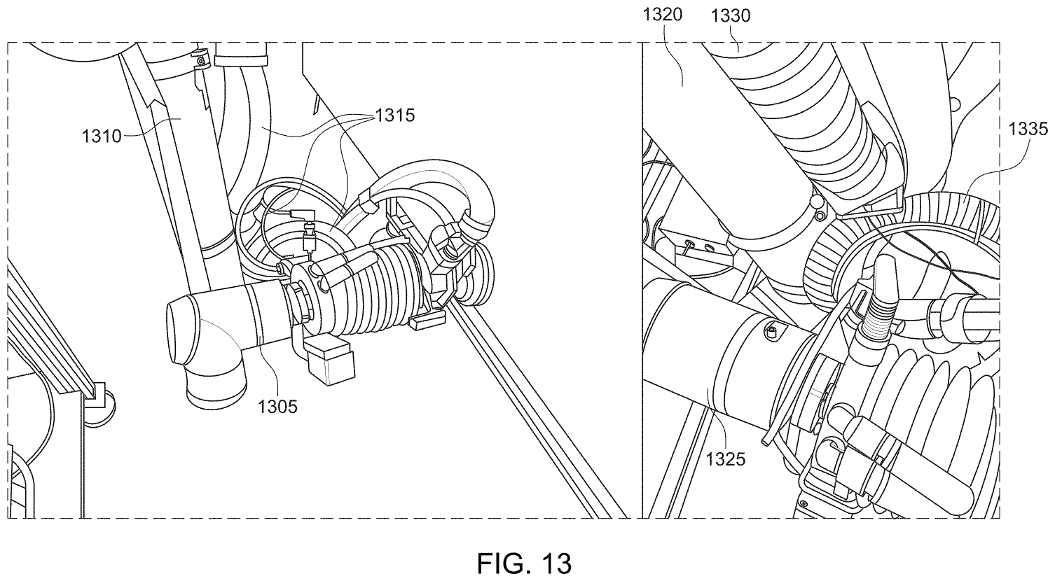

FIG. 13 illustrates cabling in a robot as well as a cabling constraint issue according to some implementations. In FIG. 13, a robot link 1305 is connected or coupled to robot link 1310 via a joint (not shown). In some implementations, liquid, air and/or voltage or current may be supplied to different parts of the robot via one or more cables or hoses 1315. In some implementations, the one or more cables are located in locations where different parts of the robot (e.g., the robot links or joints) could possibly operate in or move to. If the robot links or arms move into that area, the cables and/or hoses (and/or the robot links) may possibly be damaged. The right side of FIG. 13 illustrates two hoses or cables 1330 and 1335 that may be utilized to provide air, liquid and/or voltage or current to different parts of the robot. Hose or cable 1330 may be located in an area that is not problematic. In FIG. 13, hose or cable 1335 may be positioned between links 1305 and 1310. Accordingly, movement by one of the links 1305 and 1310 may hit or collide with hose or cable 1335 and may damage hose or cable 1335, which will severely impact robot performance. Accordingly, hose or cable constraint parameters may need to be generated and/or established for the hoses or cables to make sure the robot links 1310 and 1305 do not come in contact with any hoses or cables (e.g., cables 1315, 1330 and/or 1335) during operation of the robot.

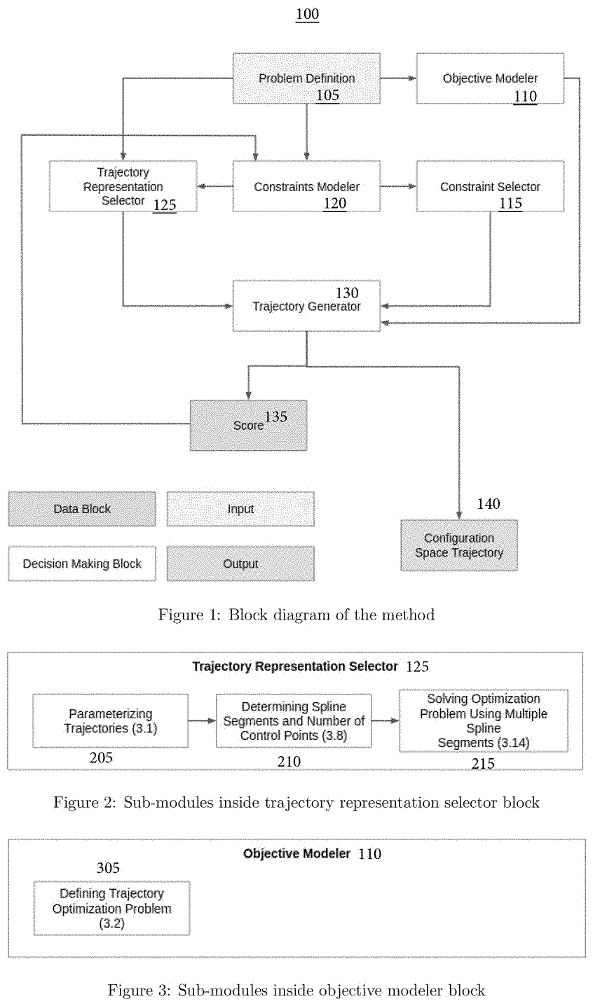

FIG. 1 illustrates a block diagram of a trajectory generation system or process according to some implementations. In some embodiments, the trajectory generation system 100 includes a problem definition module 105 where a problem is input, the problem being that the robot has to perform a task. In some implementations, the problem is into the objective modeler module 110 where goals of the trajectory to be generated are computed and/or defined. In some implementations, the problem definition module 105 may communicate with the trajectory representation selector 125. In some implementations, the constraint modeler module 120 may model and/or generate a plurality of constraints and/or constraint parameters. In some implementations, the constraint selector module 115 may select a number of (or set of) constraints to apply along with an order or priority of the application of the constraints or constraint parameters. In some implementations, the trajectory generator module 130 may receive the constraints that are selected to be applied, the objective parameters or goals, and/or an initial trajectory and may generate one or more robot trajectories. In some implementations, the trajectory generator module 130 may communicate the one or more robot trajectories to a scoring module 135. In some implementations, the generated score of the scoring module may represent a quality of the one or trajectories, a number of constraint violations of the one or more trajectories, and/or whether or not desired objection functions were met by the one or more trajectories. If the score generated for the one or more robot trajectories is over a threshold, the scoring module 135 or the trajectory generator module 130 may communicate the one or more robot trajectories to the configuration space trajectory module 140. The configuration space trajectory module 140 includes the one or more robot trajectories that are to be utilized by the robot. If the score for the one or more robot trajectories is not over a threshold score, the scoring module 135 or the trajectory generator module 130 may start the process again and utilize the one or more robot trajectories as a starting point and moves back through the successive refinement process to come up with quality robot trajectories.

FIG. 2 illustrates submodules of the trajectory representation selector module according to some implementations. In some implementations, the trajectory representation selector module 125 may include a parameterizing trajectories module 205, a spine segment and number of control point selector module 210 and an optimization module 215. In some implementations, the parameterizing trajectories module 205 may generate a parametric representation of an initial trajectory. In some implementations, module 210 may determine a number of spline segments and/or control points to be utilized in generating a trajectory. In some implementations, the optimization module 215 may use the multiple spline segments and/or control points to assist in generating the one or more robot trajectories.

FIG. 3 illustrates submodules of an objective modeler module according to some implementations. The objective modeler module 110 may include a defining trajectory optimization problem module 530. In some implementations, the defining trajectory optimization parameter module 305 may identify objectives and/or goals for the trajectory generation system 100.

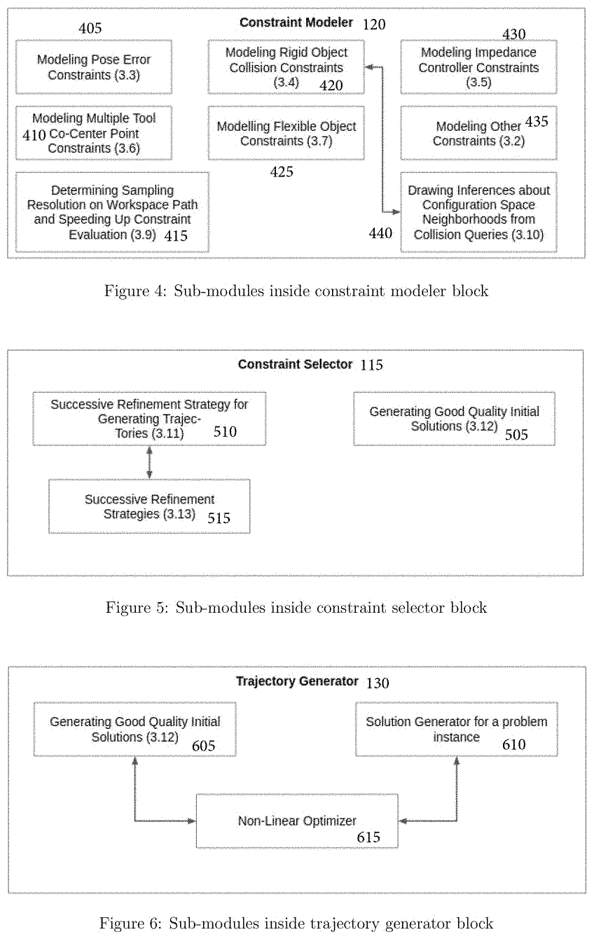

FIG. 4 illustrates a constraint modeler module 120 according to some implementations. The constraint modeler module 120 may include a number of constraint modules that include constraint functions, constraints and/or constraint parameters. The modules included in the constraint modeler module 120 include a pose error constraint module 405, a multiple tool co-center point constraint module 410, a sampling resolution determination constraint module 415, a rigid object collisions constraint module 420, a flexible object constraints module 425, an impedance controller constraints module 430, an other constraints module 435, a sensor constraint module (not shown) and a drawing inference from collision queries module 440.

FIG. 5 illustrates submodules of a constraint selector module according to some implementations. In some implementations, the constraint selector module 115 may include a generating good quality initial solutions module 505 that generates good initial quality trajectories. The constraint selector module 115 also includes a successive refinement strategy module 510 that generates a strategy for determining how and when constraints or constraint variables are to be applied. In some implementations, the successive refine strategies module 515 may then generates a plan of what constraints are to be applied and/in what order and communicates this to the trajectory generator module 130.

FIG. 6 illustrates submodules of a trajectory generator module according to some implementations. In some implementations, the trajectory generator module 130 includes a solution generator module 610 that identifies solutions for a problem instance. In some implementations, the trajectory generator module 130 may include a non-linear optimizer module 615 and/or a generating quality solutions module 605.

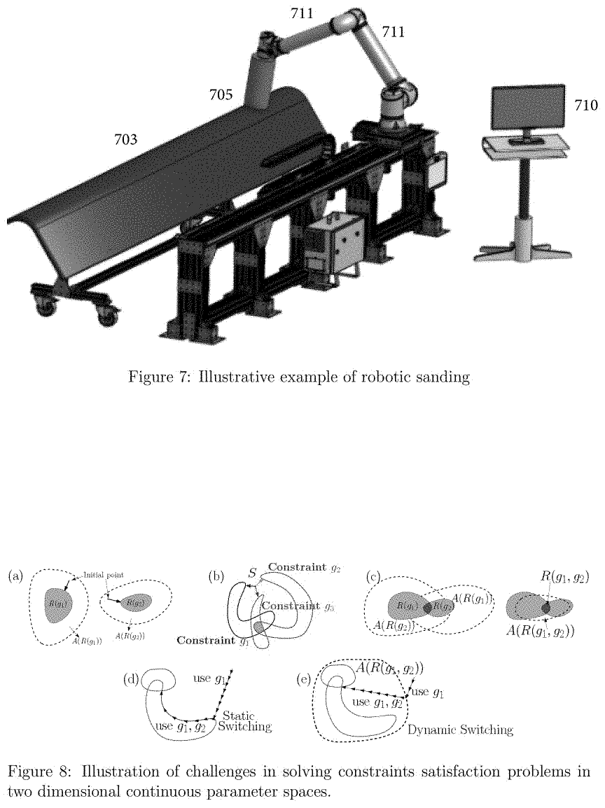

FIG. 7 illustrates a robot sanding tool according to some implementations. In some implementations, the computing device 710 may communicate one or more quality robot trajectories to the robot. In FIG. 7, the robot may include one or more links 711 and a sanding tool 705 that is to sand the part or surface 703 according to the communicated one or more quality robot trajectories.

When defining parametric trajectory representations of trajectories, the trajectory generation system may approximate each of the configuration variable trajectories as a non-uniform rational B-spline

$${( NURBS )}^{C}$$

of an appropriate order. Representation of the j^{th} configuration variable, θⱼ(s, x^{j})=Σᵢ₌₁^{N}^{_{cp}}, s∈[0,1]. In some implementations, N_{cp} may be a number of control points for the one dimensional spline curve representing θⱼ, Rx^{j}(s) is the vector of control points for θⱼ, and R_{i,k}(s) may the basis functions parametrized with arc-length parameter of the workspace curves C(s). In the parameterizing trajectories module 205 described herein, the trajectory generation system may perform adaptive search to find a right order of the curve. In some implementations, the trajectory generation system may begin with a second order and may increase the order of the curve to find better solutions. In some implementations, the trajectory generation system or process may stop when increasing the order of the curve does not lead to improvement in the solution quality.

In some implementations, an optimization problem that the trajectory generation system is trying to solve and/or determine is to find an optimal set of control points (X) for configuration variables. The defining trajectory optimization problem module 305 may be utilized to determine the optimal set of control points. In some implementations, X is a vector created by stacking the vectors x^{j}, Vⱼ. In some implementations, if the robot or robotic system has N^{d} degrees of freedom, the length of the vector X may be N^{d}×N_{cp}. In some implementations, representative objective and/or constraint functions or parameters (as shown in Equations 1-18 below) may be utilized to create an optimization instance. In some implementations, a goal for the trajectory generation system may be to find the optimal spline control points (X*) for a minimum effort or joint motion trajectory. In some implementations, in addition to collision, physics, and process-based constraints or constraint parameters, the trajectory generation system or process may also consider a constraint or constraint parameter based on position limit and/or velocity limit for the configuration variables.

$$\begin{matrix}arg {min}_{Θ ( t )} {\int }_{{t}_{i}}^{{t}_{f}} dt , s . t . & ( 1 ) \\ \underline{Θ} \leq Θ ( t ) \leq \overline{Θ} & ( 2 ) \\ \underline{\dot{Θ}} \leq \dot{Θ} ( t ) \leq \overline{\dot{Θ}} & ( 3 )\end{matrix}$$

Relative Motion Constraint among objects,

g_{curve}(C(s(t)),Θ(t))=0≤0 (4)

Collision Avoidance,g_{coll}(Θ(t))≤0 (5)

Robot's Kinematic and Dynamic Constraints,g_{robot}(Θ(t))≤0 (6)

Continuity Constraint,g_{cont}(Θ(t))≤0 (7)

Repositioning Constraint,gᵣₑₚₒ(Θ(t))≤0 (8)

Tool Velocity Constraint,gₜₒₒₗᵥₑₗ(Θ(t))≤0 (9)

Robot Controller Constraint,g_{controller}(Θ(t))≤0 (10)

Force Controller Constraint,g_{forcecontroller}(Θ(t))≤0 (11)

Impedance Controller Constraint,g_{impedancecontroller}(Θ [symbol] )≤0 (12)

Multiple Tool Co-Center Point Constraint,g_{multitcp}(Θ(t))≤0 (13)

Tool Orientation Constraint,gₜₒₒₗₒᵣᵢ(Θ(t))≤0 (14)

Sensor Constraints,gₛₑₙₛₒᵣ(Θ(t))≤0 (15)

Rigid Object Constraints,g_{rigidbody}(Θ(t))≤0 (16)

Flexible Object Constraints,g_{flexiblebody}(Θ(t))≤0 (17)

Application Specific Constraints

gⱼ(C(s(t)),Θ(t))≤0,j=0,1, . . . ,l (18)

In some implementations, the trajectory generation system may define a pose error constraint or constraint parameters as a weighted sum of position error and orientation error and this may occur in the modeling pose error constraints module 405. In some implementations, the trajectory generation system or process may automatically select position error from one of the two following types: (a) an absolute position error and (b) a position error with tolerance. Similarly, the trajectory generation system or process described herein may select one or more of the following of the following representations for orientation error: (a) a complete orientation match, (b) an orientation match along one axis, free rotation is allowed about this axis, and/or (c) an orientation match along one axis with tolerance. In some implementations, the trajectory generation system may compute or calculate position and/or orientation of coordinate frames of interest by utilizing forward kinematics (FK) for the tree (T) of robots and objects. In some implementations, the pose error representation or constraint may be automatically selected based on a context. In some implementations, the trajectory generation system may use an active learning-based approach to determine an appropriate representation or constraint to use based on workspace obstacles and/or path constraints.

Rigid-object collisions are collisions between a robot and an object in the workspace environment. Some trajectory generation systems perform collision checking by considering and/or analyzing mesh-to-mesh collisions among the objects. However, this is computationally expensive. In some implementations, the trajectory generation system described herein may represent the robots and/or environment objects as a collection of spheres, which may provide a good approximation to represent the robot and/or objects' geometries and this is performed in the modeling rigid collision constraints module 420. In these implementations, spherical representation of the robot and/or objects may provide a computational advantage for collision checking in the trajectory generation system. In these implementations, the robot and/or object representation utilized by the trajectory generation system may be conservative in order to prevent false negative results in the collision query. In some implementations, the trajectory generation system may use a hybrid scheme that selects a best representation of the collision constraints or collision constraint parameters based on an application context. In some implementations, the trajectory generation system may use machine learning to map an application context to the collision constraint or collision constraint parameters having a best representation.

A tool attached to a robot maintains contact with a workpiece in a workspace during execution and/or operation of most serial link manipulator or robot path-constrained trajectories. In some implementations, the trajectory generation system described herein may utilize impedance control to allow reflexive actions by the manipulator or tool so that the manipulator or tool may address uncertainty in a geometry of the workpiece (or surface) in order to execute and/or travel the trajectory without damaging the workpiece, tool, and/or the robot. The modeling impedance controller constraints module 430 is utilized to model issues with impedance control. In some implementations, an impedance controller may lose stability if a trajectory path passes through or very close to singularity and/or comes close to a collision. Accordingly, the trajectory generation system may generate a nominal trajectory that does not come close to singularity and/or also avoids collisions. In some implementations, the trajectory generation system may utilize an impedance controller constraint or constraint parameters to make it safe for the robot trajectory to be executed and/or performed using an impedance controller. In some implementations, the trajectory generation system may utilize a metric that quantifies how close or far a robot trajectory is from moving towards a singularity point or position and/or collisions points, which may be referred to as the impedance controller constraint or constraint parameter.

The robot tool has a surface contact while tracking the provided workspace path (C) in many manufacturing applications. This may occur, for example, as a robot performs a sanding operation on a complex surface with an orbital sander. The surface of the sander may not be able to always maintain a constant point of contact. In some implementations, the robot trajectory system described herein, utilizing the modeling multiple tool center point constraints module 410 may adaptively change a tool center point in order to maintain contact. In this implementation, with the robot trajectory system having multiple tool center points, this may give additional flexibility for the robot while following the workspace path resulting in an increase of the robot's reachability space. In some implementations, the robot trajectory system may need to consider a transition continuity while switching between multiple tool center points, which may be referred to as multiple tool center point parameters and/or constraints. In some implementations, the robot trajectory system may utilize a tool rotation measurement between points on a trajectory as a constraint or constraint parameter. In this implementation, if the tool rotation measurement is greater than a threshold value, then a tool center point constraint violation has occurred. In other words, tool rotation should be within a threshold for a robot motion to be smooth.

In some implementations, a large number of robotic applications may require the robot to carry an active device such as a power tools, and/or sensing tools. In some implementations, the active device or tools, may be connected to power cables, pneumatic tubing, and/or liquid tubing. In some implementations, the presence of these flexible cables and/or tubing that connected to the tools may need to be considered while possible robot computing tool motion to avoid any damage to the tool, its connectors or connecting devices, and/or the cable and/or tubing. In some implementations, the robot trajectory system (i.e., the modeling flexible object constraints module 425) may model or estimate the flexible cables and/or tubing as a spring damper system. In some implementations, for example, a robot system energy may increase when the more the cables and/or tubing may be rotated from a normal position in the robot. Thus, in some implementations, the Flexible Object Constraint or constraint parameters may be modeled as an energy constraint or constraint parameters, which may be minimized while computing and/or generating the one or more robot trajectories. In some implementations, the constraints or constraint parameters of the spring damper system may be tuned and/or adjusting using a Support Vector Machine (SVM)-based learning approach in the trajectory generation system. In some implementations, the SVM model of the trajectory generation system make take into account a number of cables, cable diameters of the number of cables, and/or an amount of slack provided without sagging.

Typically, one spline segment may be used to compute a joint motion trajectory required to trace the desired workspace curve. However, depending upon the length of the workspace curve, the computation time required by the trajectory generation system to compute optimal spline control points (X*) is large. Further, the computation time is dependent on number of control points N_{cp} used for spline. Thus, in order to address this issue, the trajectory generation system (e.g., the determining spline segments and number of control points module 219) may adaptively sample the workspace curve and may determine a number of spline segments N_{seg} and a number of control points for each spline N_{cp} that may be necessary for computing and/or generating a joint motion trajectory in a computationally efficient manner. In some implementations, the trajectory generation system may apply a first, second and/or third order of continuity constraints to enforce continuity between the splines. In some implementations, the trajectory generation system may vary an order of the continuity depending on the application. In some implementations, the trajectory generation system may utilize IK solutions at sampled points along the workspace curve. In some implementations, the trajectory system may generate and/or compute feasible IK solutions by utilizing an optimization routine that takes into account physical robot constraints, collision constraints, and/or process constraints. In this implementation, as an example Θ^{IK}={θ₁^{IK}, θ₂^{IK}, . . . , θ_{N}_{_{DOF}}^{IK}} represents the IK solutions (θⱼ^{IK}={θⱼ^{IK}(s):sϵS}. N_{DOF} is the total degrees of freedom in the robotic system or the dimension of a configuration space. In some implementations, the trajectory generation system may analyze the solutions, may remove the linear trend from all θⱼ^{IK}, j∈{1, . . . , N_{DOF}} and may identify a number of peaks, which may directly correlate to a number of segments N_{seg}. In some implementations, the trajectory generation system may utilize a Gaussian process regression (GPR) model that generates and outputs right combination of N_{seg} and N_{cp} for the current workspace curve by analyzing the mode of a number of peaks present in all the θ^{IK}.

During computation of joint space trajectories, an optimization routine of the trajectory generation system may evaluate several constraints or constraint parameters (e.g., robot joint constraints, collision constraints, etc.) at every point along a workspace path (C). Moreover, the trajectory generation system may evaluate a few of the constraints at discrete samples that involve not only the points on the workspace path, but also intermediate points along the trajectory to ensure safe motion between waypoints on the path. In some implementations, the overall computation time of the optimization routine in the trajectory generation system may depend on two factors: (a) resolutions of points on the workspace path (b), and (c) resolution at which the constraints are evaluated. In some implementations, if the trajectory generation system samples at a coarse resolution, this may will lead to a poor approximation. In some implementations, if the trajectory generation system samples at a very fine resolution, this may lead to higher computation time. In some implementation, the trajectory generation system may utilize an algorithm or process in the determining sampling resolution on workspace path and speeding up constraint evaluation module 415 that iteratively varies a sampling resolution on the workspace paths, which leads to reduced constraint evaluations. In some implementations, the trajectory generation system may initially select a sampling resolution Rᵢₙᵢₜ by evaluating the curvature (Kᵢ) of the workspace paths (cᵢ∈C) and their derivatives (K\dot{ }ᵢ). In some implementations, an optimization routine or process of the trajectory generation system may utilize a workspace path with sampling resolution Rᵢₙᵢₜ, and may attempt to compute or generate a joint-space trajectory. If a joint-space trajectory satisfies all of the constraints, the optimization process may converge. If the joint-space trajectory does not meet all of the constraints, then the trajectory generation system may adjust a resolution R_{X} based on constraint violations on continuity, and/or collision constraints. Moreover, the trajectory generation system may utilize an experience model for certain constraints that may utilize discrete evaluation along the trajectory (e.g., a collision constraint). The utilization of this technique may further reduce a number of constraint evaluations performed and thus improve a computation time. In some implementations, the optimization process of the trajectory generation system may assess the probability of constraint failure/satisfaction at each discrete point and may adaptively add and remove neighboring points on the entire trajectory that is being evaluated. In some implementations, the optimization process of the trajectory generation system may compute a probability of a failure/satisfaction using a Gaussian Process Regression (GPR) model that is trained online from the data collected from the previous constraint evaluations. In some implementations, the GPR model computed for collision constraints may use a collision score, and a volumetric sphere in joint configuration space to predict a probability of collision.

Drawing Inferences about Configuration Space Neighborhoods from Collision Queries—In some implementations, the trajectory generation system (e.g., the Drawing Inferences about Configuration Space Neighborhoods from Collision Queries Module 440) may extract additional information from collision queries by computing a clearance-distance for each link of the robot individually during a collision query. In some implementations, this technique results in the trajectory system being able to reduce a number of collision queries. In some implementations, the trajectory generation system may observe that robot links beyond the bottleneck link can move more based on their own distances to the nearest obstacles. By utilizing the serial-link structure of the robot and distance for each link separately, the trajectory generation system may be able to approximate free configuration space much more accurately from a single collision query. In some implementations, the trajectory generation system may reduce collision queries even in cases when one of the links closer to the base of the robot is very close to the obstacle. When a given configuration leads a robot in a collision state with respect to the workspace objects, the trajectory generation system may be able to estimate penetration distance for each robot link using a machine learning model. In this implementation, the estimated penetration distance may be used to estimate configuration space obstacles. This technique allows the trajectory generation system to approximate configuration space obstacles from small number of collision queries and avoid those configurations. Moreover, in some implementations, the trajectory generation system may utilize the physics-based simulation and machine learning models for flexible objects (e.g., cables attached to the tool that run along the robot links) to estimate how the objects are deforming as the manipulator executes the trajectory by moving the joints. This is done to ensure that the flexible objects are not stretched during the robot's motion, thus ensuring safety.

If the trajectory generation system initiates an optimization routine with a randomly generated initial solution, then the trajectory generation system may not be able to find a feasible solution within a reasonable computation time-bound (e.g., amount of time). In this case, the trajectory system may generate an infeasible solution, as well as a highly suboptimal solution, owing to the numerous local minima in this class of problems. In some implementations, the trajectory generation system (e.g., the generating good quality initial solutions module 505) may generate initial solutions utilizing the estimated N_{cp} and N_{seg} and fit splines for each configuration variable through the IK solutions (θ^{IK}) by solving the following optimization problem xⱼ⁰=ₓΣθⱼ(s,x)−θⱼ^{IK}(s), s∈S, x⁰={x₀¹, x₂⁰, . . . , x_{N}_{_{DOF}}⁰}. In some implementations, the trajectory generation system can use X⁰ as an initial solution in the third stage of our approach. For multiple spline segments, we will need to consider the continuity among segments (θⱼ(1, x^{q-1})=θⱼ(0, x^{q}), θⱼ(1, x^{q})=θⱼ(0, x^{q+1})) while solving the optimization problem.

The above-described strategy may not always produce a good initial trajectory solution. In some implementations, the trajectory generation system (e.g., using the successive refinement strategy for generating trajectories module) and may divide an overall problem into a set of simpler problems, each with a fewer degrees of freedom. In some implementations, the trajectory generation system may utilize solutions for the simpler problems to compose initial solutions for the overall problems. In some implementations, the trajectory generation system may automatically generate simpler problems by analyzing the complexity of the constraints and reducing degrees of freedom to approximate the constraints.

In some implementations, the trajectory generation system (e.g., the successive refinement strategies module 515) may utilize a successive constraint refinement strategy. If a trajectory generation system solves the optimization by considering all the constraints or constraint measurements together from the beginning, this results in a very slow computationally process. In the trajectory generation system claimed and describe herein, the trajectory generation system may apply constraints or constraint parameters successively, which leads to much improved computational performance.

FIG. 8 illustrates challenges in solving constraints in a two-dimensional continuous parameter space according to some implementations. As an example, the trajectory generation system may need to consider generating a one or more trajectories where there are n_{c} different constraints. A constraint g can have multiple disjoint regions in the parameter space that satisfy the constraint g. In some implementations, a region R(g) in the parameter space satisfies constraint g. If a randomly generated initial trajectory is utilized as a starting point, the trajectory generation system may move through the parameter space when constraint violation function is used to update this solution to reduce the constraint violation through gradient descent. In this example. If the initial trajectory is in the vicinity R(g), then the optimization process will move the initial trajectory to a solution in R(g). The region in parameter space A(R(g)) that attracts initial solutions to R(g) is called the attractor basin for R(g). R(g).R(g)⊆A(R(g)).

The probability that a given initial trajectory may move to a given region R(g) depends on the size of (R(g)). If a constraint has a large number of disjoint feasible regions, then the basin size associated with each feasible region will tend to be small and associated probabilities will be small.

In some implementations, constraint violation functions or parameters may be used to guide the initial trajectories to the feasible regions. As an example, a typical constraint violation function or parameter may operate well near a feasible region and may monotonically increase with respect to a distance from the feasible region boundary. In this example, well-behaved constraint violation function or parameters can guide the initial trajectory solution to the feasible region. However, when there are multiple feasible regions nearby, the constraint violation function or parameters does not operate as well away from each feasible regions as each feasible region tends to attract the trajectory solution towards itself

As a result, constraint violation functions may begin to behave or operate randomly and may not provide meaningful guidance. In this case, the interaction among different regions may reduce the region over which the constraint violation function or parameters behaves or operates well. In this example, the basin size may strongly correlate to region over which the constraint violation functions behave or operate well.

In some implementations, the trajectory generation system may select a right sequence for adding constraint components to the optimization procedure process and this results in solving the trajectory generation problem efficiently. In some implementations, in order to select a right sequence of constraints or constrain parameters, the trajectory generation system may need to understand basin sizes of various constraints or constraint parameters and/or also how interactions among constraints may affect the basin sizes. In some implementations, some constraints or constraint parameters may be highly correlated. Therefore, if the optimization process of the trajectory generation system may use the highly correlated constraints or constraint parameters together, this may not negatively impact the basin sizes. In some implementations, the trajectory generation system may determine an order in which the different sets of constraints or constraint parameters may be applied for a robot system. In some implementations, the trajectory generation system may determine the order of constraint application off-line or not in real time. In these implementations, the number of parameters may be large. Accordingly, to have a trajectory generation system estimating basin sizes and interaction among basin sizes by exhaustive search may not be feasible. Therefore, in the trajectory generation system describe herein, the trajectory generation system utilizes a sampling-based approach to estimate basin sizes and interactions among the basins. In some implementations, the trajectory generation system may utilize an active learning based adaptive search. In this implementation, the trajectory generation system may utilize information gathered about the basin sizes to automatically design a sequence of constraint applications to minimize an expected computation time needed to identify the one or more successful robot trajectory. In some implementations, the trajectory generation system may develop a branch and bound search to identify an optimal sequence in which to apply constraints. In some implementations, the trajectory generation system may allow introducing multiple constraints or constraint parameters together in a single phase or stage if the constraints or constrain parameters are compatible.

As an example, a trajectory generation system may be performing a two-phase process, where two sets of constraints may be applied. In a first phase, the trajectory generation system may apply g₁ and in a second phase, the trajectory generation system may apply g₂. FIG. 8(d) shows how the trajectory generation system may move through the workspace or the configuration workspace in some implementations. In some implementations, the trajectory generation system may not necessarily bring generated trajectory inside a feasible region for g₁. In these implementations, the trajectory generation system may switch to a second phase and apply g₁ and g₂. In some implementations, for example, the trajectory generation system may have used an attractor basin of g₁ first in order to be able to bring the generated robot trajectory to the attractor basin of g₁ and g₂ and then switched to applying both g₁ and g₂ (see FIG. 8(e)). By utilizing this trajectory generation process, the trajectory generation system may solve the problem much faster. In some implementations, an on-line component of a search strategy for the trajectory generation system may make exploratory moves to determine if the generated robot trajectory is within the attractor basin of a next set of constraints that may be applied in the trajectory generation process. In some implementations, this technique allows a trajectory generation system to switch to a next phase of applying constraints without waiting for the previous phase of applying constraints to be completed. In some implementations, the trajectory generation system may assess a probability of a given generated robot trajectory to be in an attractor basin for a given set of constraints. In some implementations, the trajectory generation system may assess the probability by analyzing behaviors of constraint violation functions in order to discover problem-specific heuristics for enabling effective use of successive refinement strategies.

In some implementations, the trajectory generation system (e.g., the solving optimization problem using multiple spline segments module 215) may generate robot trajectories that include multiple spline segments. In some implementations, the trajectory generation system may need to maintain a continuity between each spline segment while approximating the robot trajectory utilizing multiple spline segments. The trajectory generation system may not solve for each segment independently because that may not guarantee continuity between the spline segments. Further, the trajectory generation system may not solve the spline segments pairwise in a sequential manner because this may lead to discontinuity towards the later spline segments. In some implementations, in order to address the problems and/or issues listed above, the trajectory generation system may check compatibility of two independently generated consecutive segments (the i^{th} and the i+1^{th} segment) by an affinity score that measures comparability between Θᵢ(1) and Θᵢ₊₁(0). In these implementations, the trajectory generation system may formulate the multi-segment spline trajectory generation problem as a branch-and-bound search that utilizes an affinity score as a branch guiding heuristic. In some implementations, in order for the trajectory generation system to generate robot trajectories that include multiple spline segments, the trajectory generation system adapted the problem defined by Equation (1-18) for each of the spline segments, solved the problem for each of the spline segments and generated results and/or answers, and stored the results and/or answers for each of the spline segments. In some implementations, the trajectory generation system then ranks the consecutive segment pairs based on the affinity score for each segment pair and selected the segment pair with a maximum score. The trajectory generation system then generated a spline for one of the segments in the segment pair taking into consideration a continuity constraint with the other. In some implementations, if the trajectory generation system identifies a feasible spline segment, then the trajectory generation system recalculates the affinity scores for the spline segments and repeats the process for the remaining spline segment pairs. In the trajectory generations system does not find a feasible spline segment, the trajectory generation system may generate a spline segment for the spline segment pair with a next highest or best affinity score.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor. A computing device including one or more physical memory devices and one or more processors may perform the steps or operations described herein. Specifically, computer-readable instructions stored in the one or more physical memory devices of the computing device may be executed and/or executable by the one or more processors to perform the steps and operations described herein.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A method of generating robot trajectories for a robot device that is performing a task on a surface of an object, comprising:
capturing one or more images of the surface of the object on which the task is being performed;
generating surface parameters and/or measurements for the surface of the object based at least in part on the one or more images of the surface;
receiving one or more parameters to maximize or minimize robot objectives, the one or more parameters to maximize or minimize robot objectives including minimizing robot path length in performing the task, minimizing robot execution time for performing the task and/or minimizing robot energy consumption when performing the task;
receiving one or more motion parameters for the robot to perform the task on the surface of the object and/or receiving one or more workspace parameters receiving a plurality of constraint parameters, the constraint parameters identifying which robot task constraints are involved in performing the task;
generating an initial parametric representation of a trajectory for the robot in performing the task, the initial parameter representation of the trajectory including a number of control points and/or a number of spline segments in a path to be utilized in generating the trajectory;
generating an initial trajectory based on the initial parametric representation of the trajectory, one or more workspace parameters, the one or more motion parameters, and the one or more parameters to maximize or minimize robot objectives;
selecting a first set of constraint parameters to be applied during a first trajectory generation stage; and
performing trajectory generation, during the first trajectory generation stage, by applying the selected first set of constraint parameters to create one or more first robot trajectories.

2. The method of claim 1, further comprising:
improving performance of the one or more first robot trajectories by analyzing constraint violations in prior proposed robot trajectories for similar robot types to generate constraint violation parameters; and
applying the constraint violation parameters to the one or more first robot trajectories.

3. The method of claim 1, further comprising:
improving performance of the one or more first robot trajectories by adaptively sampling points on the one or more first robot trajectories, wherein the adaptive sampling is based, at least in part, on a shape complexity of a portion of path of the one or more first robot trajectories.

4. The method of claim 1, further comprising:
determining whether the one or more first robot trajectories include an acceptable quality robot trajectory based on the applicable constraint parameters.

5. The method of claim 4, wherein if the one or more first robot trajectories include an acceptable quality robot trajectory, communicating the acceptable quality robot trajectory to the robot.

6. The method of claim 4, wherein if the one or more first robot trajectories do not include an acceptable quality robot trajectory, further comprising:
updating the one or more first robot trajectories by adding one or more spline segments and/or one or more control points to generate one or more updated first robot trajectories.

7. The method of claim 6, further comprising:
selecting an expanded set of constraint values to be applied during a second trajectory generation phase;
generating one or more second robot trajectories, during the second trajectory generation stage, by applying the selected expanded set of constraint parameters to the one or more updated first robot trajectories;

8. The method of claim 7, further comprising:
determining whether the one or more second robot trajectories include an acceptable quality robot trajectory.

9. The method of claim 8, wherein if the one or more second robot trajectories include an acceptable quality robot trajectory, communicate the acceptable quality robot trajectory to the robot.

10. The method of claim 8, wherein if the one or more second robot trajectories do not include an acceptable quality robot trajectory, further comprising:
update the one or more second robot trajectories by adding one or more spline segments and/or one or more control points to generate one or more updated second robot trajectories.

11. The method of claim 10, further comprising:
selecting an additional expanded set of constraint parameters; and
generating one or more third robot trajectories, during the third optimization stage, by applying the selected additional expanded set of constraint parameters to the one or more updated second robot trajectories;

12. The method of claim 11, wherein if the one or more third robot trajectories include an acceptable quality robot trajectory, communicate the acceptable quality robot trajectory to the robot.

13. The method of claim 12, wherein if the one or more third robot trajectories do not include an acceptable quality robot trajectory, continuing to perform the below actions until an acceptable quality robot trajectory is generated:
update one or more current robot trajectories by adding one or more spline segments and/or one or more control points to generate one or more updated robot trajectories;
select additional expanded sets of constraint parameters; and
generating new robot trajectories, during a subsequent optimization stage, by applying the selected additional expanded sets of constraint parameters to the one or more updated robot trajectories.

14. The method of claim 12, wherein the determining of whether the one or more first, second, third or additional robot trajectories includes an acceptable robot trajectory includes comparing the one or more first, second, third or additional robot trajectories against the objective function parameters and if the objective function parameters are not met or exceeded, the one or more first, second, third or additional robot trajectories are determined to be poor quality robot trajectories.

15. The method of claim 11, wherein the determining of whether the one or more first, second, third or additional robot trajectories includes an acceptable robot trajectory includes determining whether or not there have been any constraint violations or constraint parameter violations and if so, the one or more first, second, third or additional robot trajectories are of poor quality.

16. The method of claim 1, wherein the workspace parameters include location parameters of the robot, the surface parameters or measurements, location measurements of other objects in the workspace where the robot is located, and/or configuration parameters of the robot.

17. The method of claim 1, wherein the constraint parameters include relative motion constraint among object constraint parameters, continuity constraint parameters, robot kinematic and/or dynamic constraint parameters, tool orientation constraint parameters, tool velocity constraint parameters, and/or rigid object parameters.

18. The method of claim 1, wherein the constraint parameter include sensor constraint parameters, robot controller constraint parameters, force controller constraint parameters; impedance controller constraint parameters; and/or flexible object constraint parameters, collision constraint parameters, repositioning constraint parameters, multiple tool co-center point constraint parameters, and/or application specific constraint parameters.

19. The method of claim 1, wherein the task to be performed is sanding the surface of the object, spraying or painting the surface of the object, deburring the surface of the object, grinding the surface of the object, buffing the surface of the object, or polishing the surface of the object.

20. The method of claim 1, wherein the one or more motion parameters includes a path for the robot to follow in performing the task on the surface of the object in the workspace.
